(19) United States
(12) Patent Application Publication
(10) Pub. No.: US 2008/0062456 A1
(43) Pub. Date: Mar. 13, 2008

(54) PRINT MANAGEMENT DEVICE, STORAGE MEDIUM FOR PRINT MANAGEMENT PROGRAM, PRINT ANALYSIS SYSTEM, PRINT SYSTEM, DOCUMENT ISSUANCE SYSTEM, PRINT MANAGEMENT METHOD, AND COMPUTER DATA SIGNAL

(75) Inventor: Junichi Matsunoshita, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/687,110

(22) Filed: Mar. 16, 2007

(30) Foreign Application Priority Data
Sep. 8, 2006 (JP) 2006-243782

(51) Int. Cl. G06F 3/12; G06F 15/00

(52) U.S. Cl. 358/1.15

(57) ABSTRACT

A print management device includes a sending unit that sends to a print location a composite electronic document, in which an original electronic document requested to be printed and identification information for identifying the requested print are combined; a print electronic document acquisition unit that acquires a print electronic document, generated on the basis of the composite electronic document, from a printer at the print location; and an evaluation unit that evaluates a reliability of printing by verifying whether the acquired print electronic document corresponds to the composite electronic document.

### PRIORITY INFORMATION

This application claims priority from Japanese Patent Application No. 2006-243782, filed on Sep. 8, 2006.

### BACKGROUND

1. Technical Field

The present invention relates to a storage medium for a print management program, a print management device, a print analysis system, a print system, a document issuance system, a print management method, and a computer data signal.

2. Related Art

Document data that are printed are sometimes encrypted or digitally signed to ensure the security of the transmission of the document data to a printing location. However, the document data are not fully protected during the period from decryption at the printing location to the completion of printing. Nor are the document data protected along a route to a printer if the document data are not encrypted during the transmission to the printer.

### SUMMARY

According to an aspect of the invention, there is provided a print management device including a sending unit that sends to a print location a composite electronic document, in which an original electronic document requested to be printed and identification information for identifying the requested print are combined; a print electronic document acquisition unit that acquires a print electronic document, generated on the basis of the composite electronic document, from a printer at the print location; and an evaluation unit that evaluates the reliability of printing by verifying whether the acquired print electronic document corresponds to the composite electronic document.

### BRIEF DESCRIPTION OF THE DRAWINGS

Exemplary embodiment(s) of the present invention will be described by reference to the following figures, wherein:

FIG. 1 is a diagram showing an example of the configuration of a document issuance system;

FIG. 2 is a diagram showing an example of the configuration of a computer;

FIG. 3 is a diagram showing an example of composite document data in a print format; and

FIG. 4 is a diagram showing an example of stored data.

### DETAILED DESCRIPTION

An exemplary embodiment will be described below.

The following describes the exemplary embodiment using an example of a system in which various documents, such as an official certificate, are remotely issued. In this system, an applicant applies to an issuance server, installed in a municipal office, for the issuance of a document from a remotely installed application terminal such as one in a community hall or in the applicant's home, receives the requested document data (electronic data) on the same or a different terminal, and causes a printer to output the received document data. A document, which refers broadly to general documents prepared for printing and display, does not have to include characters and may include drawings.

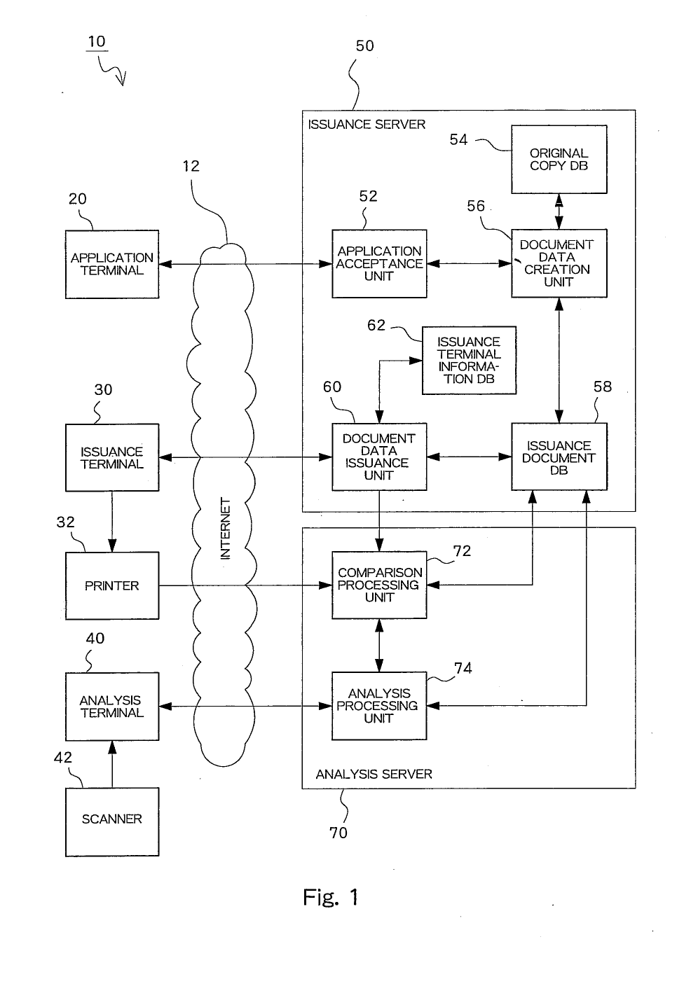

FIG. 1 is a block diagram showing the general configuration of a document issuance system in this exemplary embodiment. A document issuance system 10 is a system built on the Internet 12. The document issuance system 10 includes an application terminal 20, an issuance terminal 30, a printer 32, an analysis terminal 40, and a scanner 42 that are used as client devices, and an issuance server 50 and an analysis server 70 that are used as server devices.

The application terminal 20 is a terminal used by the user to apply to the issuance server 50 for the issuance of a document such as a certificate. The issuance terminal 30 is a terminal that receives document data, issued from the issuance server 50, and prints the received document data on the printer 32. The printer 32 is a printer, connected to the issuance terminal 30, that prints (issues) document data received from the issuance terminal 30. The printer 32 also sends to the analysis server 70 intermediate data (an intermediate-format electronic document for printing) or final data (a final-format electronic document for printing), which have been used for printing. The analysis terminal 40 is a terminal that requests the analysis server 70 to analyze the reliability of an issued document and, at the same time, receives the analysis result from the analysis server 70 for display. The scanner 42, connected to the analysis terminal 40, reads a document for analysis, generates scan image data (an electronic document that has been read), and sends the generated data to the analysis terminal 40.

The application terminal 20, the issuance terminal 30, and the analysis terminal 40 can be configured by installing programs in the computer. Any type of computer; for example, a PC (Personal Computer), may be used.

When the printer 32 sends a print instruction to the issuance terminal 30, print data (electronic document for printing) are usually generated from the original document data on the issuance terminal 30, which instructs the printer to print, or on the printer 32 (or a print server when the printer 32 has a print server). Print data are not limited to a single type of print data. That is, print data are sometimes converted (one or more times) to intermediate print data before the final print data are generated. Today, the following two modes are widely used for processing print data. In one mode, the issuance terminal 30 uses the printer driver to convert document data to PDL (Page Description Language) data in a specific format (intermediate print data) and sends the converted data to the printer 32. The printer 32 decomposes the PDL data to convert them to the final print data (final data for printing) and prints the data. In the other mode, the printer driver on the issuance terminal 30 converts document data to image (raster) data (intermediate print data). The issuance terminal 30 compresses the image data to generate compressed image data (also intermediate print data) and sends the data to the printer. The printer 32 decompresses the compressed image data back to the image data (the final print data) and prints the data.

The application terminal 20, the issuance terminal 30, the printer 32, the analysis terminal 40, and the scanner 42 are installed, for example, in a home, a convenience store, or a community hall. If data must be printed on a special print form, the devices described above may be installed in a public place such as a community hall.

The issuance server 50 is a server that accepts an application from the application terminal 20 and issues a document. The issuance server 50 includes an application acceptance unit 52, an original copy DB (database) 54, a document data creation unit 56, an issuance document DB 58, a document data issuance unit 60, and an issuance terminal information DB 62.

The application acceptance unit 52 accepts a document issuance application from the application terminal 20. Upon receiving an application, the application acceptance unit 52 generates an issuance number (identification information) and notifies the application terminal 20 of the issuance number. The application acceptance unit 52 also notifies the document data creation unit 56 of acceptance of the application as well as the issuance number. The original copy DB 54 is a database in which original copy data are stored. The original copy data may be complete data or incomplete data (for example, form data whose items are not completely filled in).

The document data creation unit 56 acquires original copy data from the original copy DB 54 or processes original copy data as necessary to prepare document data (original electronic document) corresponding to the issuance application. Subsequently, the document data creation unit 56 combines the document data with the issuance number to create composite document data (composite electronic document) that are generated data. The issuance document DB 58 is an issuance document database in which composite document data, created by the document data creation unit 56, are accumulated. Rather than generating and accumulating composite document data each time a request is received, it is also possible to generate in advance composite document data, to which appropriate identification data are added.

When an issuance number is entered from the issuance terminal 30, the document data issuance unit 60 acquires the corresponding composite document data from the issuance document DB 58 and sends them to the issuance terminal 30. In addition, on the basis of the information stored in the issuance terminal information DB 62, the document data issuance unit 60 notifies a comparison processing unit 72 included in the analysis server 70 about the printer 32 which is to be used for printing. The issuance terminal information DB 62 is a database in which, when multiple issuance terminals 30 are present, stores the correspondence between identification information on each issuance terminal (for example, its IP address) and identification information on the printer 32 connected to that issuance terminal 30 (for example, its IP address).

The analysis server 70 includes the comparison processing unit 72 and an analysis processing unit 74. The comparison processing unit 72 compares print data, sent from the printer 32, with composite document data stored in the issuance document DB 58 to evaluate the reliability of printing. Subsequently, the comparison processing unit 72 associates the evaluation result with the composite document data and stores the association in the issuance document DB 58. The analysis processing unit 74 analyzes image data to detect an issuance number embedded in the image data. In addition, the analysis processing unit 74 references the issuance document DB 58, determines whether or not the printing corresponding to the issuance number is valid, and returns the result to the analysis terminal 40.

The issuance server 50 and the analysis server 70 are each built from a computer. Any type of computer can be used and, depending upon the operation load, a computer ranging from a PC to a supercomputer may be used.

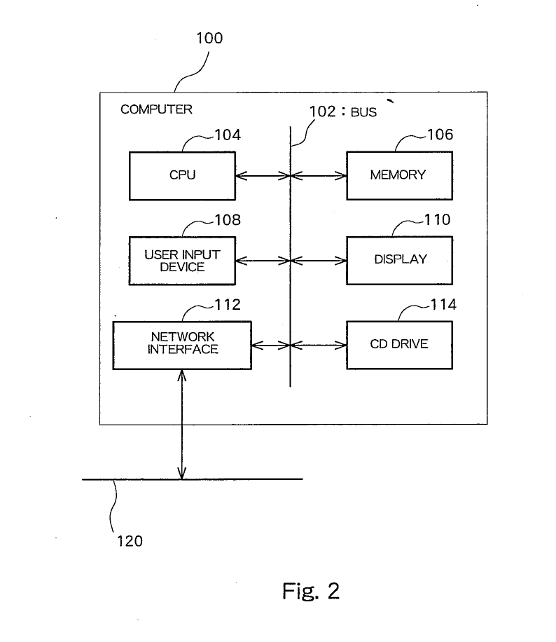

With reference to FIG. 2, a typical configuration of the computer will now be described. A computer 100 shown in the figure is a typical computer used to build the application terminal 20, the issuance terminal 30, the analysis terminal 40, the issuance server 50, and the analysis server 70. That is, the computer 100 has the following hardware components: a bus 102 that serves as the communication path of data, a CPU (Central Processing Unit) 104 connected to the bus 102, a memory 106, a user input device 108, a display 110, a network interface 112, and a CD drive 114.

The CPU 104, which is a device for performing operation processing, performs various operation processing functions and the hardware component control functions under program control. The memory 106 is a storage device such as a semiconductor memory or a magnetic disk in which programs and data are stored. The user input device 108 is a keyboard and a mouse that accept a user input. The display 110 is a device that displays image data. The network interface 112, which is connected to a network 120, allows communication between the computer 100 and an external device via the network 120. The CD drive 114 is a device that reads data from, and writes data to, a CD (Compact Disc) that serves as a storage medium.

Programs can be installed when the computer is shipped from the factory. Alternatively, after the computer is shipped from the factory, the programs may be installed by receiving a program data signal via the CD drive 114 or the network interface 112.

The configuration of the computer 100 described above may be changed in various ways. For example, one or more of the user input device 108, the display 110, and the CD drive 114 may be omitted. The computer 100 may also be configured as an image-processing device having a printer or a scanner. In addition, the computer 100 may constitute a distributed processing system where the hardware components are distributed on the network 120 in such a way that they can communicate with each other.

The application terminal 20, the issuance terminal 30, and the analysis terminal 40 may be on different computers 100, or may be built on the same computer 100. Similarly, the issuance server 50 and the analysis server 70 may be built on different computers 100 or on the same computer 100.

Next, the following describes the operation of the document issuance system 10.

The user operates the application terminal 20 installed in the home to connect to the application acceptance unit 52 in the issuance server 50 via the Internet 12. The UI (User Interface) is displayed on the display screen of the application terminal 20 to allow the user to perform the application procedure via the UI.

First, the user enters a user ID and a password, or presents an IC card, for authentication so that the system can identify the user. Then, the application acceptance unit 52 displays on the UI screen of the application terminal 20 the fields of the items necessary for the issuance, such as name, address, and type of document to be issued (for example, resident card, tax payment certificate, etc.). After the user enters the necessary items (application information), the application acceptance unit 52 accepts the input, generates an issuance number, and outputs the issuance number and the application information to the document data creation unit 56.

On the basis of the application information, the document data creation unit 56 acquires original copy data from the original copy DB 54. After that, the document data creation unit 56 combines the original copy data with a seal image in which the coded issuance number is embedded as a digital watermark. The digital watermark is a technology for embedding information in such a way the user cannot visually identify it. The document data creation unit 56 also combines the original copy data with the issuance number in a character string format in such a way the user can visually identify it.

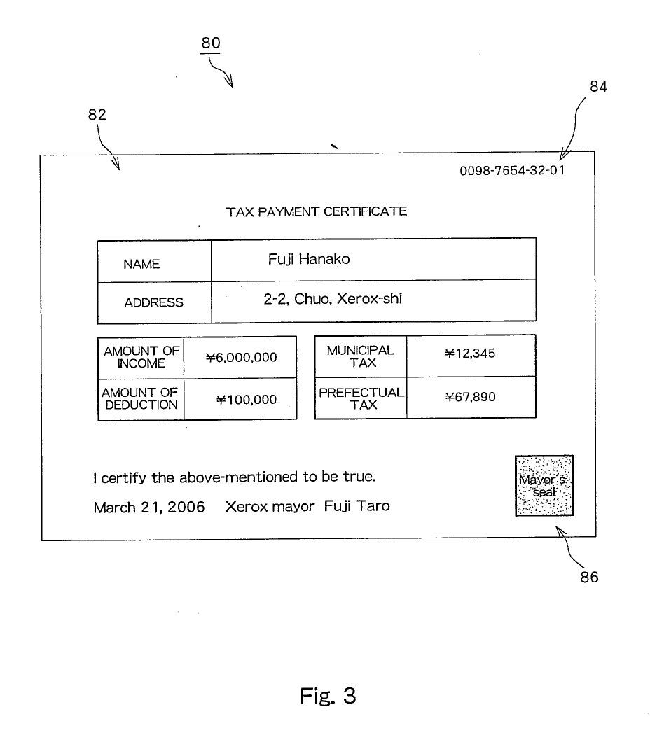

FIG. 3 is a diagram showing the printed format of composite document data 80 generated as described above. The figure shows the composite document data 80 representing a tax payment certificate that includes tax payment certificate items 82, an issuance number 84, and a watermark-embedded seal 86. The tax payment certificate items 82 are created by filling the tax payment certificate form, which is the original copy data, with the applicant's data. More specifically, “Fuji Hanako” is entered in the name field, “2-2, Chuo, Xerox-shi” in the address field, “6000000” yen in the amount of income field, “100000” yen in the amount of deduction field, “12345” yen in the municipal tax field, and “67890” yen in the prefectural tax field. In addition, “March,” “21,” and “2006” are set as the month, day, and year in the issuance date field. The tax payment certificate items 82 are document data requested by the applicant; that is, the original electronic document that the user requests to print.

The issuance number 84 is identification information data included visibly (in a human-readable manner) in the original electronic document. The watermark-embedded seal 86 is not the seal of the mayor, who is the issuer, but a seal generated by encoding the issuance number and embedded invisibly into the original electronic document. The issuance number in the watermark-embedded seal 86 is read through analysis of the read program.

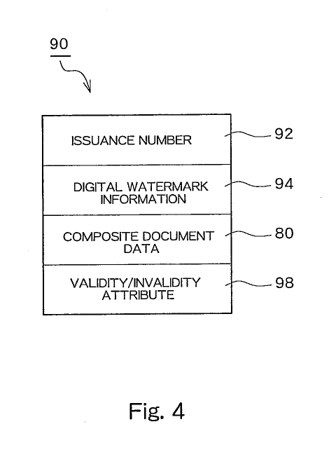

The document data creation unit 56 stores the created composite document data 80, as well as the related data, into the issuance document DB 58. FIG. 4 is a diagram schematically showing the structure of data stored in the issuance document DB 58. Stored data 90 shown in the figure are a group of data related to the composite document data 80. That is, the stored data 90 include the composite document data 80 as well as an issuance number 92, digital watermark information 94, and a validity/invalidity attribute 98. The issuance number 92, also included in the composite document data 80, is stored separately in this database as numeric data to facilitate searching for the composite document data 80. The digital watermark information 94 is data that are embedded as the digital watermark in a pre-encoded form. The validity/invalidity attribute 98 is an attribute assigned by evaluating the reliability of the printing of the composite document data 80, as will be described later. If the printing is evaluated as reliable, the validity attribute is assigned; if the printing is evaluated as not reliable, the invalidity attribute is assigned. It is good practice to assign the invalidity attribute before evaluation of the reliability.

After the data are stored in the issuance document DB 58, the document data creation unit 56 notifies the application acceptance unit 52 that the data are stored. In response to the notification, the application acceptance unit 52 displays on the UI screen of the application terminal 20 a message, which indicates that the application has been accepted, as well as the issuance number.

When the application terminal 20 also serves as the issuance terminal 30, the UI screen of the application terminal 20 is changed immediately to the UI screen of the issuance terminal 30. On the terminal, a message is displayed to the user to prompt him or her to acquire the issuance document corresponding to the issuance number. In this case, the user can make an acquisition request via the UI. Meanwhile, the user can also request to acquire the issuance document from the issuance terminal 30 provided separately from the application terminal 20. In this case, the user enters the user ID and the password, or presents the IC card, for authentication so that the system can identify the user, logs in from the issuance terminal 30, and enters the already-acquired issuance number via the UI displayed on the screen.

The issuance terminal 30 sends the issuance number, corresponding to the acquisition request, to the document data issuance unit 60 of the issuance server 50. In response, the document data issuance unit 60 acquires the document data, corresponding to the received issuance number, from the issuance document DB 58, encrypts and digitally signs the acquired document data via the public key cryptosystem, and sends the document data back to the issuance terminal 30. The document data issuance unit 60 acquires the IP address of the printer 32, connected to the issuance terminal 30, from the issuance terminal information DB 62 and sends the acquired IP address and the transmission date/time information to the comparison processing unit 72. If the issuance document DB 58 does not include the issuance number and the corresponding composite document data, the document data issuance unit 60 displays information to this effect on the issuance terminal 30 and terminates the processing.

Upon receipt of the composite electronic document data, the issuance terminal 30 decrypts the data and then starts the document display software to display the data on the screen. The user confirms that the content is correct and instructs the printer to print (issue) the composite electronic document data. In this case, the printer driver corresponding to the printer 32 generates print data from the composite electronic document data and sends the generated data to the printer 32. For example, if the connected printer 32 is designed for printing PDL data, the PDL data is generated as print data and are sent to the printer 32. If the printer 32 is designed for printing compressed image data, the image data are converted and compressed and then sent to the printer 32.

Upon receiving the print data, the printer 32 decodes or expands the data or further converts the data as needed to generate the final print data. Then, on the basis of the print data, the printer 32 prints on paper. In this way, the user can receive the document printed on paper. In parallel with the print processing, the printer 32 sends the print data, which are received or are obtained by the subsequent conversion processing, to the comparison processing unit 72 of the analysis server 70. Data of any type are sent, so long as they are readable by the analysis server 70. In general, it should be noted that the alteration of print data can be monitored in various ways as the print data that are transmitted come to more closely resemble the final print data.

The comparison processing unit 72 outputs the received print data to the analysis processing unit 74. The analysis processing unit 74 detects the digital watermark information embedded in the seal data included in the print data and extracts the issuance number from the digital watermark information. For example, when the received print data are PDL data, the analysis processing unit 74 finds an image data combination instruction included in the PDL data to extract the seal image data and detects the digital watermark information from the seal image data. If the PDL data are not altered, the digital-watermark embedded seal image can always be extracted and the issuance number can be acquired. On the other hand, if the received print data are compressed image data, the analysis processing unit 74 can expand the data and extract the digital watermark information from the seal image data included in the acquired image data. The issuance number can be detected from the digital watermark information in accordance with the specification of the digital watermark information. The issuance number thus detected is output to the comparison processing unit 72. If the issuance number cannot be acquired from the print data, the analysis processing unit 74 sends a message to the issuance terminal 30 to notify that incorrect document data may be sent and, subsequently, terminates the processing.

Although in the above description the issuance number is detected from the print data, it is also possible to send the issuance number from the printer 32. The issuance terminal 30 has information on the issuance number. Thus, this issuance number is encrypted or digitally signed for alteration and is sent to the analysis server 70 via the printer 32.

The comparison processing unit 72 searches the issuance document DB 58 in the issuance server 50 to acquire the composite image data corresponding to the issuance number received from the analysis processing unit 74. The comparison processing unit 72 converts the acquired composite image data to the same data format as that of the received print data and compares them. For example, if the print data are PDL data, the comparison processing unit 72 converts the composite document data, acquired from the issuance document DB 58, to PDL data. If the print data are compressed image data, the comparison processing unit 72 converts and compresses the composite document data acquired from the issuance document DB 58 to generate compressed image data. Alternatively, the comparison processing unit 72 may expand the print data to convert them to image data and, at the same time, convert the composite document data, acquired from the issuance document DB 58, to image data. In either case, both sets of data to be compared are converted to the same data format before being compared. In addition, instead of using the composite image data stored in the issuance document DB 58, it is also possible for the comparison processing unit 72 to use the data with which the issuance number is not yet combined, such as the original copy data stored in the original copy DB 54. In this case, although the issuance numbers cannot be compared, the issuance numbers can be compared at a later time, or, depending upon the application, the issuance numbers need not be compared.

If the comparison result indicates that the two sets of data are identical or the difference therebetween falls within an allowable range, the comparison processing unit 72 determines that the composite document data received from the issuance server 50 have not been altered along the path to the printer 32. In this case, the comparison processing unit 72 sets the validity/invalidity attribute of the composite document data, stored in the issuance document DB 58, to “valid.” In contrast, if the comparison result indicates that the two sets of data are not identical and the difference falls outside the allowable range, the comparison processing unit 72 determines that the composite document data have been altered along the path. In this case, the comparison processing unit 72 sets the validity/invalidity attribute, stored in the issuance document DB 58, to “invalid.”

The comparison processing unit 72 also sets the validity/invalidity attribute, stored in the issuance document DB 58, to “invalid” if the time required for sending the print data from the printer 32 exceeds a pre-set time. The time required is calculated, for example, from the transmission date/time of the composite document data.

Although in the above description the validity/invalidity verification is made in parallel with the print processing on the printer 32, it is also possible to interrupt the print processing on the printer 32 to make the validity/invalidity verification before printing. Doing so stops the printer 32 from printing a document that is found invalid, thus preventing issuance of the invalid document.

Next, the following describes the process in which the system checks, in response to an inquiry from the user, whether or not a printed document has been altered.

In this process, the user first starts the document analysis software via the UI of the analysis terminal 40 to read a document placed on the platen of the scanner 42. The generated scan image data are encrypted and digitally signed via the public key cryptosystem before being sent to the analysis processing unit 74.

Upon receipt of the scanned image data, the analysis processing unit 74 detects the digital watermark information embedded in the seal image in the scanned image data and extracts the issuance number from the digital watermark information. After that, the analysis processing unit 74 acquires from the issuance document DB 58 the composite document data, the digital watermark information, and the validity/invalidity attribute, corresponding to the issuance number.

Next, the analysis processing unit 74 checks if the digital watermark information, extracted from the scanned image data, is authentic, by reference to the digital watermark information acquired from the issuance document DB 58. In general, if a match is found, the digital watermark information is determined to be authentic. The analysis processing unit 74 also checks whether the acquired validity/invalidity attribute is valid or invalid. If the above check shows that the extracted digital watermark information is authentic and if the validity/invalidity attribute is “valid,” the document for which the user sends the inquiry is determined to be valid. In contrast, if the extracted digital watermark information is unauthentic or if the validity/invalidity attribute is “invalid,” the document for which the user sends the inquiry is determined to be invalid. The analysis processing unit 74 sends this determination result, as well as the composite document data acquired from the issuance document DB 58, to the analysis terminal 40.

The received determination result and the composite document data are displayed on the screen of the analysis terminal 40. If the displayed determination result indicates that the document is valid, the user determines that the document was not altered when issued; in contrast, if the displayed determination result indicates that the document is invalid, the user determines that the document was altered. The user can also compare the composite document data that are displayed with the data of the document that is owned by the user.

Instead of using the scanner 42 to read a document, the user can also enter the issuance number, described in the document as a character string, from the analysis terminal 40 to check if the document is authentic. Instead of extracting the issuance number from the digital watermark information included in the scanned image data, the analysis processing unit 74 can read the issuance number included in the scanned image data as a character string. Note that, in the mode in which digital watermark information is not used, there is a possibility that alteration of the issuance number cannot be detected.

In the mode described above, the digital watermark technology is used to combine an issuance number into document data. Instead of this technology, there may be used a technology for combining encoded data, such as a bar code or a QR code, visibly into document data. Encoding should be used with encryption (for keeping the data secret) for preventing data from being altered, but encryption is sometimes not necessary and is skipped for easy implementation. Rather than use of such a code, it may be the case that only a character string identifiable by the human being is combined into the data.

An example of issuing a document has been described above. In addition to the application described above, the present invention can be broadly applied when an instruction is sent to the printer or when document data to be printed is owned (managed) by the user who makes the print request.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A print management device comprising:
a sending unit that sends to a print location a composite electronic document, in which an original electronic document requested to be printed and identification information for identifying the requested print are combined;
a print electronic document acquisition unit that acquires a print electronic document, generated on the basis of the composite electronic document, from a printer at the print location; and
an evaluation unit that evaluates a reliability of printing by verifying whether the acquired print electronic document corresponds to the composite electronic document.

2. The print management device according to claim 1, further comprising:
a management unit that manages a correspondence between an evaluation result and the identification information.

3. The print management device according to claim 1, wherein
the evaluation unit evaluates the reliability of printing before the printer starts printing, and
the print management device further comprises a permission unit that permits the print location to start printing via the printer if an evaluation result indicates that the printing is reliable.

4. The print management device according to claim 1, wherein
the evaluation unit performs the verification by comparing the acquired print electronic document with the composite electronic document.

5. The print management device according to claim 4, wherein
the evaluation unit comprises:
a detection unit that detects the identification information from the acquired print electronic document; and
a search unit that searches for the composite electronic document in which the identification information is combined.

6. The print management device according to claim 1, wherein
the evaluation unit evaluates the printing as reliable only if a duration from a time the sending unit sends the composite electronic document to a time the print electronic document acquisition unit acquires the print electronic document falls within an allowable range.

7. The print management device according to claim 1, wherein
the print electronic document is a final format electronic document directly used for printing.

8. The print management device according to claim 1, wherein
the sending unit sends the composite electronic document by ensuring safety through a public key cryptosystem.

9. The print management device according to claim 1, wherein
the identification information, which is encoded for security, is combined into the composite electronic document.

10. The print management device according to claim 2, further comprising:
an identification information acquisition unit that acquires the identification information on printing already having been performed; and
a determination unit that determines a reliability of the printing from the evaluation result corresponding to the acquired identification information.

11. The print management device according to claim 10, wherein
the identification information acquisition unit acquires the identification information on the basis of a read electronic document generated by reading a form, and
the determination unit determines the reliability of printing on the form.

12. A computer-readable medium storing a program causing a computer to execute a process for print management, the process comprising:
sending to a print location a composite electronic document, in which an original electronic document requested to be printed and identification information for identifying the requested print are combined;
acquiring a print electronic document, generated on the basis of the composite electronic document, from a printer at the print location; and
evaluating a reliability of printing by verifying whether the acquired print electronic document corresponds to the composite electronic document.

13. The computer-readable medium according to claim 12, the process further comprising:
associating an evaluation result with the identification information.

14. The computer-readable medium according to claim 12, wherein
when the evaluation is performed, the reliability of printing is evaluated before the printer starts printing,
the process further comprising:
permitting the print location to start printing via the printer if an evaluation result indicates that the printing is reliable.

15. The computer readable medium according to claim 12, wherein
the verification is performed by comparing the acquired print electronic document with the composite electronic document.

16. The computer readable medium according to claim 12, wherein
when the evaluation is performed, the printing is evaluated as reliable only if a duration from a time the sending unit sends the composite electronic document to a time the print electronic document acquisition unit acquires the print electronic document falls within an allowable range.

17. The computer-readable medium according to claim 12, wherein
the print electronic document is a final format electronic document directly used for printing.

18. A print analysis system comprising:
a print management device that comprises:
a sending unit that sends to a print location a composite electronic document, in which an original electronic document requested to be printed and identification information for identifying the requested print are combined;
a print electronic document acquisition unit that acquires a print electronic document, generated on the basis of the composite electronic document, from a printer at the print location;
an evaluation unit that evaluates a reliability of printing by verifying whether the acquired print electronic document corresponds to the composite electronic document;
a management unit that manages a correspondence between an evaluation result and the identification information;
an identification information acquisition unit that acquires the identification information on printing already having been performed; and
a determination unit that determines a reliability of the printing on the basis of the evaluation result corresponding to the acquired identification information; and
a reader that reads a form to generate a read electronic document, wherein
the identification information acquisition unit acquires the identification information from the read electronic document generated by the reader, and
the determination unit determines the reliability of printing on the form.

19. A print system comprising:
a print management device that comprises:
a sending unit that sends to a print location a composite electronic document, in which an original electronic document requested to be printed and identification information for identifying the requested print are combined;
a print electronic document acquisition unit that acquires a print electronic document, generated on the basis of the composite electronic document, from a printer at the print location; and
an evaluation unit that evaluates a reliability of printing by verifying whether the acquired print electronic document corresponds to the composite electronic document;
an acquisition unit that acquires the composite electronic document from the print management device;
a generation unit that generates the print electronic document on the basis of the acquired composite electronic document; and
the printer that prints the generated print electronic document and sends the electronic document to the print management device.

20. A document issuance system comprising:
a management unit that manages a correspondence between an electronic document to be issued and issuance identification information;
an issuance device that converts a composite electronic document, in which the electronic document and the issuance identification information are combined, to a print electronic document, prints the electronic document as a paper document, and issues the paper document;
an acquisition unit that acquires the print electronic document from the issuance device;
an evaluation unit that evaluates a reliability of the issued paper document by verifying whether the acquired print electronic document corresponds to the electronic document to be issued; and
a management unit that manages a correspondence between an evaluation result and the issuance identification information.

21. A print management method comprising:
sending to a print location a composite electronic document, in which an original electronic document requested to be printed and identification information for identifying the requested print are combined;
acquiring a print electronic document, generated on the basis of the composite electronic document, from a printer at the print location; and
evaluating a reliability of printing by verifying whether the acquired print electronic document corresponds to the composite electronic document.

22. A computer data signal embodied in a carrier wave for enabling a computer to perform a process for print management, the process comprising:
sending to a print location a composite electronic document, in which an original electronic document requested to be printed and identification information for identifying the requested print are combined;
acquiring a print electronic document, generated on the basis of the composite electronic document, from a printer at the print location; and
evaluating a reliability of printing by verifying whether the acquired print electronic document corresponds to the composite electronic document.
